(19) United States
(12) Patent Application Publication
(10) Pub. No.: US 2009/0189650 A1
(43) Pub. Date: Jul. 30, 2009

(54) PLL circuit including voltage controlled oscillator having voltage-current conversion circuit

(75) Inventors: Satoshi Fujino, Kanagawa (JP); Ryota Yamamoto, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/320,327

(22) Filed: Jan. 23, 2009

(30) Foreign Application Priority Data
Jan. 30, 2008 (JP) 2008/018977

(51) Int. Cl. H02M 11/00

(52) U.S. Cl. 327/103

(57) ABSTRACT

A Phase-Locked Loop (PLL) circuit includes a voltage-controlled oscillator. The voltage-controlled oscillator includes a voltage-current conversion circuit and a current-controlled oscillation circuit. The voltage-current conversion circuit includes an input transistor having a gate terminal connecting a control voltage, a first transistor connected in series to the input transistor, a second transistor connected as a current-mirror to the first transistor, to generate a control current, and a current source connected in parallel to the first transistor. The current-controlled oscillation circuit oscillates at a frequency according to the control current.

### BACKGROUND OF THE INVENTION

1. Field of the Invention

The present invention relates to a phase-locked loop (PLL) circuit and in particular, to a PLL circuit including a voltage-controlled oscillator (VCO) wherein a voltage-current conversion circuit is used.

2. Description of Related Art

PLL has since been often used for the purpose of controlling a frequency of communications equipment such as a mobile phone, wireless equipment, and so forth.

FIG. 7 is a block diagram showing the basic configuration of a PLL circuit. A PLL circuit 1 comprises a phase frequency detector (PFD) 2 for comparing phase of a reference clock signal IN with phase of a feedback signal FD, a charge pump (CP) 3, a low-pass filter (LPF) 4, a voltage-controlled oscillator (VCO) 5, and an N frequency divider (N-DIV) 6.

The phase frequency detector compares phase of the reference clock signal IN with phase of a feedback signal FD, that is, a feedback signal of the voltage-controlled oscillator 5, a frequency thereof being divided by the frequency divider 6, thereby outputting a phase error. The charge pump circuit is activated according to the phase error, and the low-pass filter 4 extracts a d-c component of a signal outputted from the charge pump circuit 3, thereby outputting a control voltage VC. An oscillation frequency is controlled by the control voltage VC such that the reference clock signal IN coincides in frequency with the feedback signal FD, whereupon a clock signal OUT having a frequency obtained by multiplying the frequency of the reference clock signal is obtained from the voltage-controlled oscillator 5. Further, a current generation circuit (ISRC) 7 generates a free-running current IFREE, thereby supplying the free-running current IFREE to the voltage-controlled oscillator 5.

FIG. 8 is a voltage-controlled oscillator 5 of a PLL circuit shown in Patent Document 1 (Japanese Patent Application Laid Open No. 2007-129501). The voltage-controlled oscillator 5 comprises a voltage-current conversion circuit 51 for converting a control voltage Vin into a control current Iout corresponding to a voltage value of the control voltage Vin, and a current-controlled oscillation circuit 52 for varying an oscillation frequency according to the control current Iout. The voltage-current conversion circuit 51 has an N-channel MOS transistor MN1 with a resistor R inserted on the source side thereof, a P-channel MOS transistor MP1 connected in series to the N-channel MOS transistor MN1, and a P-channel MOS transistor MP2 connected in current-mirror to the P-channel MOS transistor MP1. And a drain current of the MOS transistor MP2 is supplied as the control current Iout to the current-controlled oscillation circuit 52. With the current-controlled oscillation circuit 52, the oscillation frequency generated by a ring oscillator undergoes variation according to the control current Iout.

The voltage-current conversion circuit, and the current-controlled oscillation circuit make up the voltage-controlled oscillator, and current sensitivity of each of the circuits undergoes variation due to variations in process, variations in power supply voltage, and variations in temperature. The variation of the current sensitivity brings about variation in the oscillation frequency of the voltage-controlled oscillator VCO. FIG. 9 shows a frequency characteristic of the current-controlled oscillation circuit. In the figure, the vertical axis indicates the oscillation frequency F, and the horizontal axis indicates the control current Iout. Thus, the frequency characteristic of the current-controlled oscillation circuit is under influence of an effect of the variation in the current sensitivity. Further, FIG. 10 shows a volt-ampere characteristic of the voltage-current conversion circuit 51. In the figure, the vertical axis indicates the control current Iout, and the horizontal axis indicates the control voltage VC. It is evident from FIG. 10 that the volt-ampere characteristic undergoes variations according to the current sensitivity of the voltage-current conversion circuit.

In Patent document 2 (Japanese Patent Application Laid Open No. 2007-60588), there has been disclosed a technology whereby a voltage-current conversion circuit is provided with a variable resistance circuit for determining a control current, and a variable resistance value of the variable resistance circuit is adjusted according to variations in process, to thereby obtain a control current unaffected by the variations in process.

### SUMMARY

Referring to FIG. 8, operation of the voltage-current conversion circuit 51 is described hereinafter. When the control voltage VC increases in the voltage-current conversion circuit 51, the NMOS transistor MN1 is turned ON, whereupon the control current Iout is caused to flow to the PMOS transistor MP2 by the agency of the resistor R connected to the NMOS transistor MN1, and the control voltage VC.

Because the NMOS transistor MN1 whose gate terminal connects the control voltage VC will operate in weak inversion region where the control voltage VC is low, the volt-ampere characteristic will indicate nonlinearity as shown in FIG. 10. Thereafter, when a voltage value of the control voltage VC increases to exceed the threshold voltage of the NMOS transistor MN1, the NMOS transistor MN1 will operate in strong inversion region, whereupon the volt-ampere characteristic will indicate linearity. Normally, variation in gain is greater in a region of the volt-ampere characteristic, indicating nonlinearity. Accordingly, a current range where the volt-ampere characteristic indicates linearity is adopted as an application range of the control current Iout in order to stably operate a PLL circuit.

However, it is well known that with the voltage-current conversion circuit 51, the current sensitivity thereof undergoes variation due to variations in process, variations in power supply voltage, variations in temperature, and so forth, as described in the foregoing. Accordingly, as shown in FIG. 10, a portion of a current range, indicating the nonlinearity of the volt-ampere characteristic, differs according to the current sensitivity. For example, if current sensitivity is high, a region indicating the nonlinearity of the volt-ampere characteristic is large in a region where the voltage value of the control voltage VC is low. For this reason, if the current sensitivity is high, the current range large in variation of gain will become wider. Therefore, a region large in variation of gain will create a bottleneck for expanding the application range of the control current Iout as required.

As an exemplary aspect of the present invention, a Phase Lock Loop (PLL) circuit includes a voltage-controlled oscillator. The voltage-controlled oscillator includes a voltage-current conversion circuit and a current-controlled oscillation circuit. The voltage-current conversion circuit includes an input transistor having a gate terminal connecting a control voltage, a first transistor connected in series to the input transistor, a second transistor connected in current-mirror to the first transistor, to generate a control current, and a current source connected in parallel to the first transistor. The current-controlled oscillation circuit oscillates at a frequency according to the control current.

An amount of current flowing through the input transistor represents the sum of an amount of the current flowing through the first transistor, and an amount of the current fed by the current source. Since the current source is provided, and the current therefrom is forced to flow to the input transistor, a current amount is reduced to the extent of an amount of the current flowing through the first transistor. Accordingly, the control current outputted from the second transistor represents the difference when the amount of the current fed by the current source is subtracted from the amount of the current flowing through the input transistor, so that it is possible to cut off a portion of the volt-ampere characteristic, indicating nonlinearity.

The exemplary aspect of the present invention can provide a voltage current conversion circuit wherein variation in gain is checked by cutting off a portion of the volt-ampere characteristic, indicating nonlinearity. It is therefore possible to obtain a PLL circuit capable of carrying out stable operation.

### BRIEF DESCRIPTION OF THE DRAWINGS

The above and other exemplary aspects, advantages and features of the present invention will be more apparent from the following description of certain exemplary embodiments taken in conjunction with the accompanying drawings, in which:

FIG. 1 is a block diagram of a voltage-controlled oscillator according to a first exemplary embodiment of the invention;

FIG. 2 is a circuit diagram of a voltage-current conversion circuit 11 according to the first exemplary embodiment of the invention;

FIG. 3 is a diagram showing a volt-ampere characteristic of the voltage-current conversion circuit;

FIG. 4 is a diagram showing another volt-ampere characteristic of the voltage-current conversion circuit;

FIG. 5 is a circuit diagram of a current generation circuit;

FIG. 6 is a circuit diagram of a voltage-controlled oscillator according to a second exemplary embodiment of the invention;

FIG. 7 is a block diagram showing a basic configuration of a PLL circuit;

FIG. 8 is a circuit diagram of a voltage-controlled oscillator of a related art;

FIG. 9 is a diagram showing a frequency characteristic of a current-controlled oscillation circuit; and

FIG. 10 is a diagram showing a volt-ampere characteristic of a voltage-current conversion circuit of a related art.

### DETAILED DESCRIPTION OF THE EXEMPLARY EMBODIMENTS

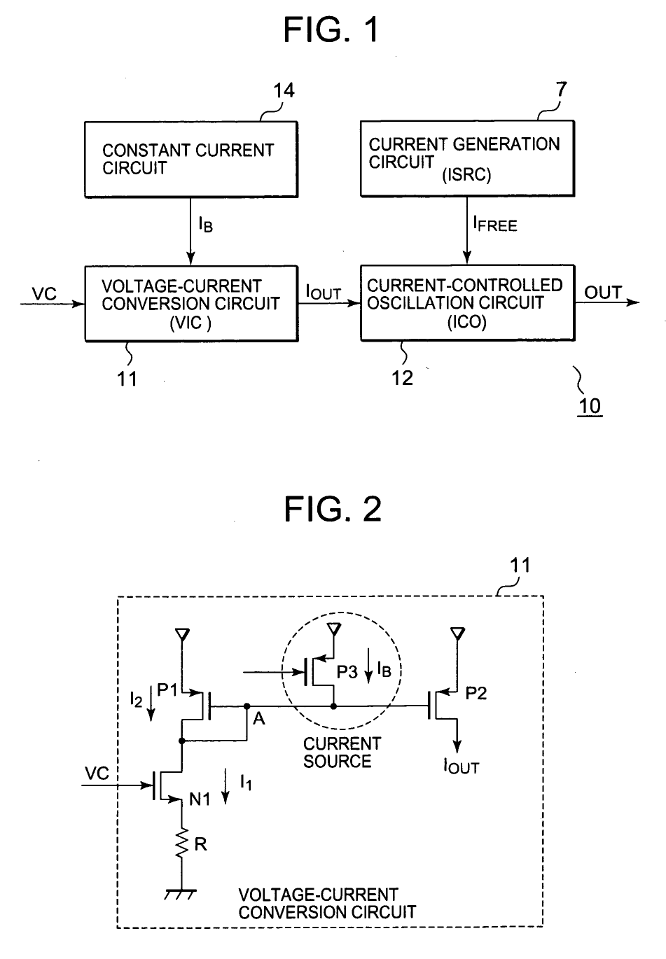

FIG. 1 is a block diagram of a voltage-controlled oscillator 10 according to an exemplary embodiment of the invention. The voltage-controlled oscillator 10 includes a voltage-current conversion circuit (VIC) 11 to which a current IB is fed, and a current-controlled oscillation circuit (ICO) 12. A constant current IFREE is fed to the current-controlled oscillation circuit 12, determining a free-running frequency of the current-controlled oscillation circuit 12.

FIG. 2 is a circuit diagram of the voltage-current conversion circuit 11. A control voltage VC is fed to a gate of an N-channel MOS transistor N1. A resistor R is provided between a source of the NMOS transistor N1, and the ground potential. A P-channel MOS transistor P1 having a gate connected to a drain is connected to a drain of the NMOS transistor N1. A PMOS transistor P2 is connected in current-mirror to the PMOS transistor P1, and a control current Iout is outputted from a drain of the PMOS transistor P2. Further, there is provided a PMOS transistor P3 functioning as a current source 13 connected in series to the NMOS transistor N1, and connected in parallel to the PMOS transistor P1, for outputting the current IB.

The current IB is generated by a current generation circuit 14 shown in FIG. 5. The current generation circuit 14 has a constant current circuit 15 comprising an NMOS transistor N4 connected in series to a PMOS transistor P4 between a power supply potential VDD, and a ground potential VSS, an NMOS transistor N5 connected in current-mirror to the NMOS transistor N4, and a resistor Rfix connected between the NMOS transistor N5, and the ground potential. The current generation circuit 14 further comprises a PMOS transistor P6 having a gate mutually connected to a gate of a PMOS transistor P5, an NMOS transistor N6 connected in series to the PMOS transistor P6, and an NMOS transistor N7 connected in current-mirror to the NMOS transistor N6, and a PMOS transistor P7 connected in series to the NMOS transistor N7. The PMOS transistor P7 is connected in current-mirror to the PMOS transistor P3 of the current source 13. By setting a mirror ratio to an “n” multiple, it is possible to obtain the current IB “n” times as large as a constant current Iref flowing through the NMOS transistor N5. The resistor Rfix is composed of the same element as an element of the resistor R of the voltage-current conversion circuit.

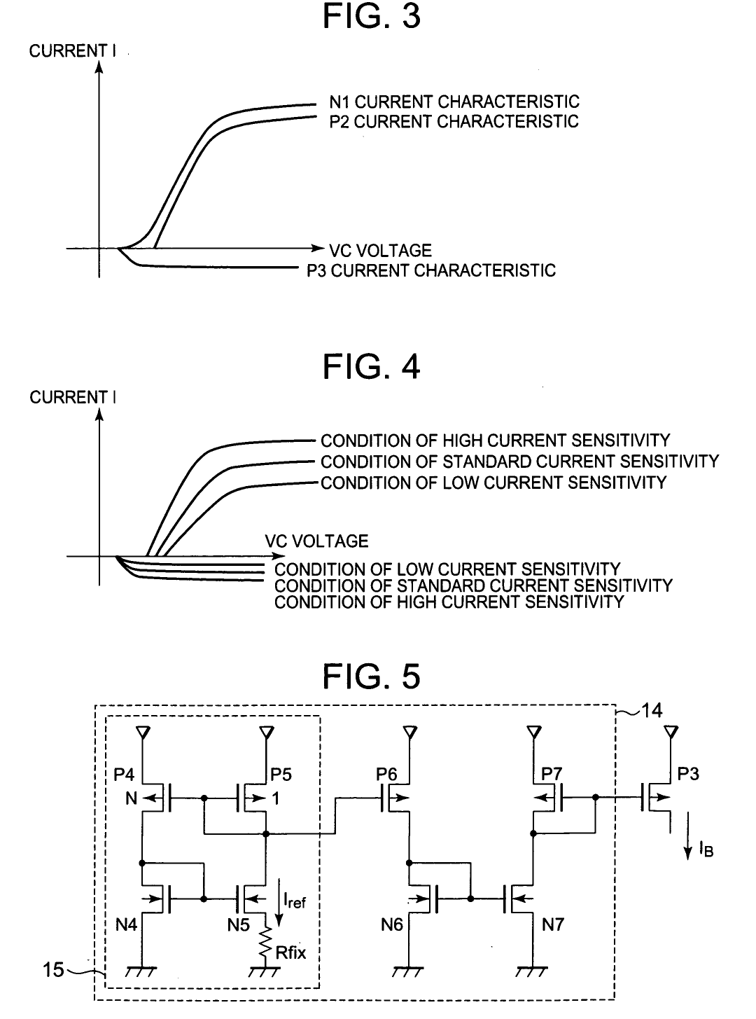

Next, operation of the voltage-current conversion circuit 11 is described hereinafter with reference to FIG. 3.

Upon application of the control voltage VC to the NMOS transistor N1, a current I1 flows thereto. The current source 13 outputs the current IB so as to flow to the drain of the NMOS transistor N1. Because the NMOS transistor N1 operates in weak inversion region where the control voltage VC is low, and the current IB is forcibly fed from the current source 13, a current I2 is not generated in the PMOS transistor P1. Thus, the control current Iout is not outputted.

When the voltage value of the control voltage VC further increases to thereby cause the NMOS transistor MN1 to operate in strong inversion region, potential at point A falls. Thus, the PMOS transistor P1 is turned ON, and the current I2 starts flowing, whereupon the control current Iout corresponding to the current I2 is outputted from the PMOS transistor P2. However, the PMOS transistor P3 keeps flowing the current IB, so that the current I2 flowing through the PMOS transistor P1 corresponds to the difference when the current IB is subtracted from the current I1 flowing through the NMOS transistor N1.

Thus, during the NMOS transistor N1 operating in the weak inversion region, the control current Iout is not outputted. On the other hand, during the NMOS transistor N1 operating in the strong inversion region, the control current Iout is outputted. Accordingly, a portion of the control current Iout, where the volt-ampere characteristic in the region of a low control voltage VC indicates nonlinearity, is cut off, so that the voltage-current conversion circuit 11 can give only a portion of the control current Iout, where the volt-ampere characteristic in the region of the low control voltage VC indicates linearity, to the current-controlled oscillation circuit 12. Thus, the voltage-current conversion circuit having reduced variation in gain can be acquired, thereby enabling a PLL circuit stable in operation to be provided.

FIG. 4 shows a volt-ampere characteristic of the voltage-current conversion circuit 11 in the case of voltage sensitivity undergoing variation. This volt-ampere characteristic corresponds to the volt-ampere characteristic shown in FIG. 10, in the case where the current source 13 is not provided, after displaced downward along the vertical axis by a portion of the volt-ampere characteristic, corresponding to the current IB.

The resistor Rfix of the current generation circuit 14 shown in FIG. 5 is composed of the same element as that for the resistor R of the voltage-current conversion circuit 11, having the same characteristic against the current IB of the current source 13 as the voltage-current conversion circuit 11 has. As a result, in the case where the current sensitivity is high (a resistance value of the resistor R is small) in the voltage-current conversion circuit 11, a current value of the current IB increases, as shown in FIG. 4, so that the current IB large in value will be subtracted from the current I1. On the other hand, in the case where the current sensitivity is low (the resistance value of the resistor R is large), the current value of the current IB decreases, so that only the current IB small in value will be subtracted from the current I1. Thus, as shown in FIG. 4, the region of the volt-ampere characteristic, indicating nonlinearity, will be sufficiently cut off under a condition that the current sensitivity is high. On the other hand, the maximum value of the control current Iout under a condition that the current sensitivity is low will not largely decrease. That is, even if the volt-ampere characteristic, in the case where the current source 13 is not provided, is displaced downward along the vertical axis by the portion of the volt-ampere characteristic, corresponding to the current IB, this will not cause large variation in the application range of the control current Iout under the condition that the current sensitivity is low. Accordingly, a range of the control current Iout, indicating linearity in the volt-ampere characteristic, is expanded, so that the application range of the control current Iout can be expanded.

Further, if a region of the volt-ampere characteristic in the region where the control voltage is low VC, indicating nonlinearity, is cut off, this will suffice, so that a large current is not required of the current IB. For example, if the current IB is substantially equivalent to the drain current flowing through the NMOS transistor N1 when the threshold voltage of the NMOS transistor N1 is delivered to the gate of the NMOS transistor N1, this will suffice. Furthermore, a precise current value is not required of the current IB either. Accordingly, it is possible use the current IB in common with the free-running current IFREE of the current-controlled oscillation circuit 12.

Still further, with the present exemplary embodiment, the free-running current IFREE is fed to the current-controlled oscillation circuit 12. By so doing, it is possible to carry out a stable oscillation operation at a predetermined frequency according to the free-running current IFREE even in a region where the control current Iout becomes zero.

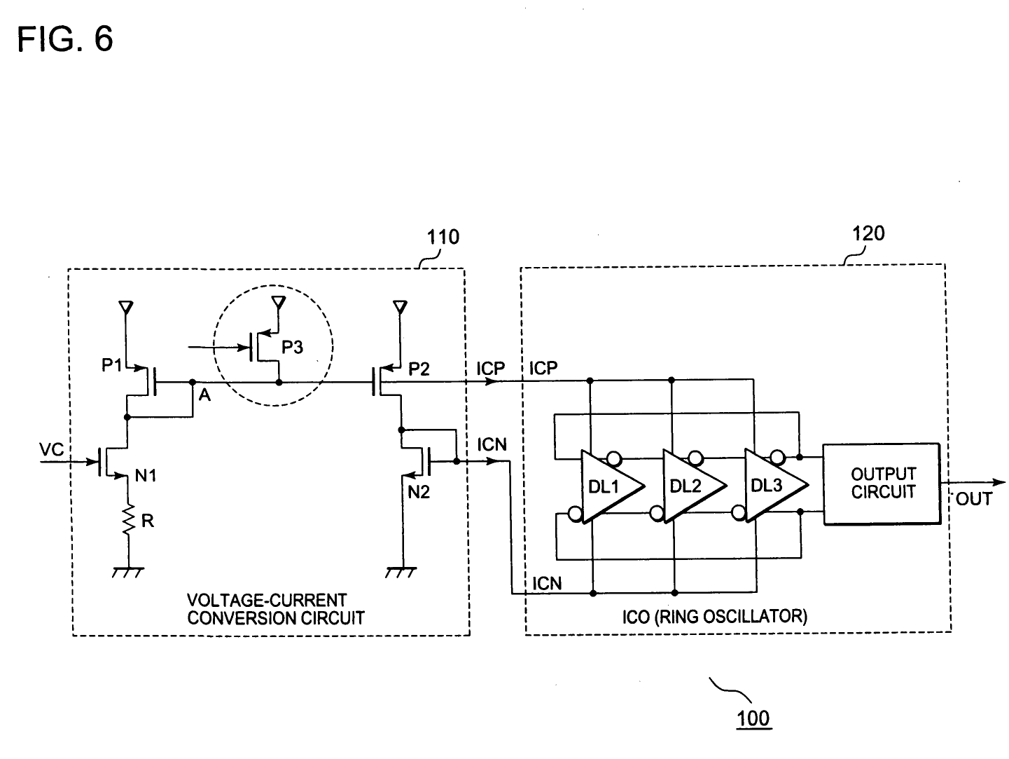

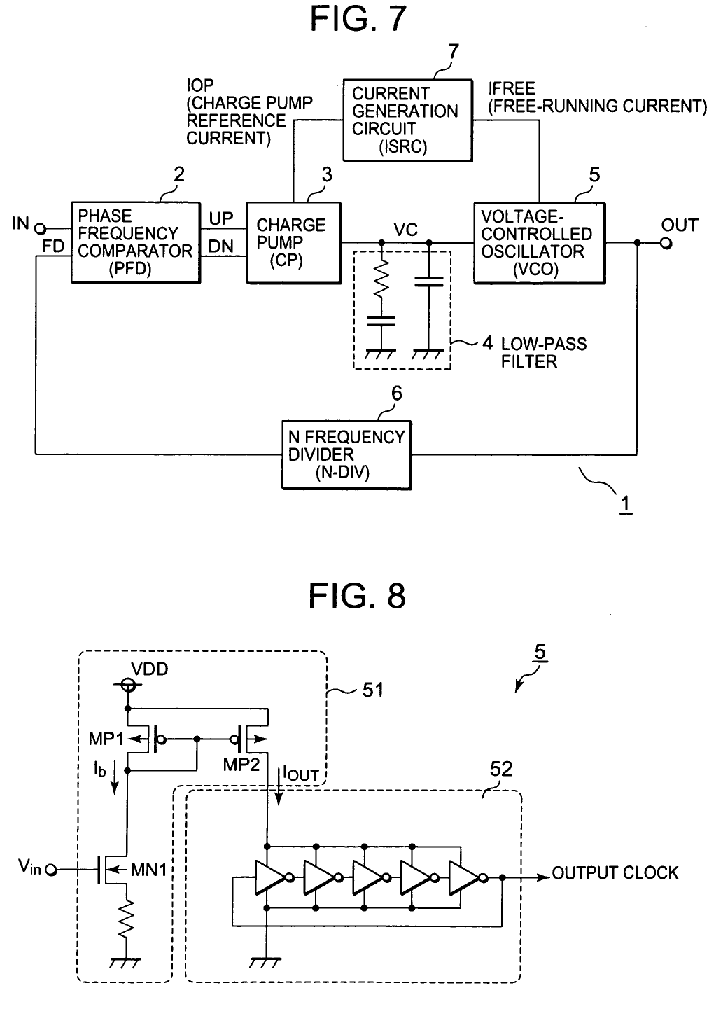

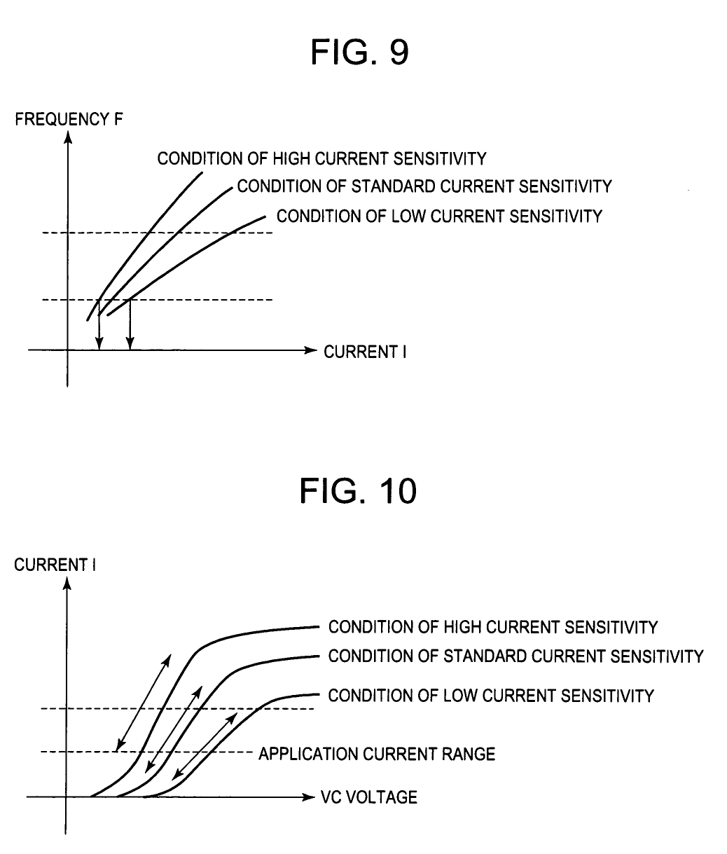

Next, a second exemplary embodiment of the invention is described hereinafter with reference to FIG. 6. As to constituent elements in the figure, corresponding to those in FIG. 2, description thereof is omitted

A voltage-controlled oscillator 100 according to the exemplary embodiment comprises a current-controlled oscillation circuit (ICO) 120, and a voltage-current conversion circuit 110 for feeding control currents ICP, ICN, respectively, to the current-controlled oscillation circuit 120.

In contrast to the voltage-current conversion circuit 11 shown in FIG. 2, the voltage-current conversion circuit 110 further comprises an NMOS transistor N2 connected in series to the PMOS transistor P2 shown in FIG. 2, the NMOS transistor N2 having a gate connected to a drain. The current-controlled oscillation circuit 120 is provided with a ring oscillator comprising differential delay circuits DL1, DL2, and DL3. With the current-controlled oscillation circuit 120, an operating current of each of the differential delay circuits DL1, DL2, and DL3 is controlled according to the respective control currents ICP, ICN, thereby controlling an oscillation frequency of the current-controlled oscillation circuit 120.

With the present exemplary embodiment as well, the current IB is forcibly fed from the current source 13, so that it is possible to cur off a portion of each of the control currents ICP, ICN, where the volt-ampere characteristic indicates nonlinearity. With such a configuration as described, the respective control currents ICP, ICN, less in variation of gain, can be fed to the ring oscillator composed of the differential delay circuits.

Thus, the exemplary embodiments of the present invention can provide a voltage current conversion circuit wherein variation in gain is checked by cutting off a region of the volt-ampere characteristic, indicating nonlinearity. In addition, the exemplary embodiments of the present invention have an advantageous effect in that there is not much increase in circuit scale because the present invention is accomplished by simple addition of a configuration for the purpose of allowing flow of a current to be subtracted.

Further, forming the resistor of the current generation circuit and the resistor of the voltage-current conversion circuit by use of the same kind of element can adjust an amount of the current to be subtracted according to voltage sensitivity. As a result, the application range of the control current can be expanded.

It is to be pointed out that the present invention be not limited to those exemplary embodiments described in the foregoing and that changes and variations may be made in the invention without departing from the spirit or scope thereof.

Further, it is noted that Applicant's intent is to encompass equivalents of all claim elements, even if amended later during prosecution.

What is claimed is:

1. A Phase-Locked Loop (PLL) circuit having a voltage-controlled oscillator, said voltage-controlled oscillator comprising:
a voltage-current conversion circuit including:
an input transistor having a gate terminal connecting a control voltage;
a first transistor connected in series to the input transistor;
a second transistor connected as a in current-mirror to the first transistor, to generate a control current; and
a current source connected in parallel to the first transistor; and
a current-controlled oscillation circuit oscillating at a frequency according to the control current.

2. The PLL circuit according to claim 1, wherein the current source includes a third transistor placed at a side of a drain terminal of the input transistor, and coupled in parallel to the first transistor.

3. The PLL circuit according to claim 1, wherein the current source generates a substantially constant current so as to flow to the first transistor.

4. The PLL circuit according to claim 1, further comprising:
a current generation circuit which generates a constant current, wherein a current generated by the current source comprises a mirror current of the constant current.

5. The PLL circuit according to claim 4, wherein the constant current is fed as a free-running current to the current-controlled oscillation circuit.

6. The PLL circuit according to claim 4,
wherein the current generation circuit comprises a constant current circuit,
wherein the constant current circuit includes:
fourth and fifth transistors connected in series between a power supply and a ground supply;
a sixth transistor connected as a current-mirror to the fourth transistor;
a seventh transistor connected in series to the sixth transistor;
and
a resistor connected in series to the seventh transistor, and
wherein the resistor and a source resistor connected to the input resistor are comprised of the same element.

7. The PLL circuit according to claim 1, wherein the voltage-current conversion circuit further comprises:
a fourth transistor, connected in series and diode-connected, to the second transistor,
wherein gate voltages of the second and fourth transistors are respectively fed to control nodes on a plus side and a minus side of the current-controlled oscillation circuit.

8. The PLL circuit according to claim 1,
wherein the input transistor is a N channel type transistor having a first terminal coupled to a first power source line supplied with a first power source voltage via a resistor,
wherein the first transistor is a first P channel type transistor having first terminal coupled to a second power source line supplied with a second power source voltage different from the first power source voltage, having a second terminal coupled to a second terminal of the input transistor,
wherein the second transistor is a second P channel type transistor having a first terminal coupled to the second power source line and having a second terminal outputting the control current,
wherein the current source includes a third P channel type transistor having a first terminal coupled to the second terminal of the first transistor, and having a second terminal coupled to the second power source line,

9. A phase-locked loop circuit, comprising:
a voltage-controlled oscillator which outputs a first clock signal in response to a voltage;
a frequency divider which responds to the first clock signal to produce a second clock signal;
a phase frequency detector which compares a phase of an input signal and a phase of the second clock signal, to produce a control signal; and
a charge pump which produces the voltage based on the control signal,
wherein the voltage-controlled oscillator includes:
a voltage-current conversion circuit which receives the voltage to produce a first current;
a current-controlled oscillation circuit which receives the first current to produce the first clock signal; and
a constant current source which produces a second current to apply the second current to the voltage-current conversion circuit so that the current-controlled oscillation circuit is operated when a voltage/current characteristic of the voltage-current conversion circuit is within a linear characteristic.

10. The phase-locked loop circuit as claimed in claim 9, wherein the current-controlled oscillation circuit is operated substantially only when the voltage/current characteristic of the voltage-current conversion circuit is within the linear characteristic.

11. The phase-locked loop circuit as claimed in claim 9,
wherein the voltage-current conversion circuit includes a transistor which includes a control gate terminal connecting the voltage,
wherein the constant current source supplies the second current to the transistor, to modify a current to be flowed into the transistor when the voltage is within a voltage where the transistor operates in a non-linear characteristic.

12. The phase-locked loop circuit as claimed in claim 11,
wherein the constant current source supplies the second current to the transistor to reduce the current to be flowed into the transistor.

13. The phase-locked loop circuit as claimed in claim 12,
wherein the constant current source supplies the second current such that substantially no current flows to the transistor, so that the voltage-current conversion circuit does not produce the first current when the voltage is within a voltage where the transistor operates in the non-linear characteristic.

14. The phase-locked loop circuit as claimed in claim 9,
wherein the voltage-current conversion circuit comprises:
a first transistor of a N channel type which receives the voltage;
a second transistor of a P channel type which received the second current;
a third transistor of the P channel type which produces the first current based on a state of the first transistor and the second current from the second transistor.
